(19) United States
(12) Patent Application Publication
(10) Pub. No.: US 2009/0108622 A1
(43) Pub. Date: Apr. 30, 2009

(54) TARPAULIN LOCKING AND TENSIONING MECHANISM

(75) Inventors: Everest DAMSI, Burlington (CA); Graeme LOWRY, Arva (CA)

Correspondence Address: LANG MICHENER, BCE PLACE, P.O. BOX 747, SUITE 2500, 181 BAY STREET, TORONTO, ON, M5J 2T7, CA

(73) Assignee: ROLL-TITE INC., Norwich (CA)

(21) Appl. No.: 12/258,008

(22) Filed: Oct. 24, 2008

Related U.S. Application Data
(60) Provisional application No. 60/982,930, filed on Oct. 26, 2007.

(30) Foreign Application Priority Data
Oct. 26, 2007 (CA) 2607924

(51) Int. Cl. B60J 7/06; B60J 7/12

(52) U.S. Cl. 296/100.15; 160/328

(57) ABSTRACT

The invention comprises a tensioning assembly for a tarpaulin, comprising: a) a track for mounting a bow for supporting the tarpaulin, the track enabling longitudinal movement of the bow along the track; b) a universal support coupled to bow and operative to support a rod, the rod being oriented substantially parallel to the track; c) a stop element, the stop element moveable from a position over the track to a position removed from said track, and said stop element operative to engage the rod when positioned over the track; and d) a tensioning adjustment mechanism, as part of one of the universal support, the rod and the stop element, the tensioning adjustment mechanism operative to adjust the position of the rod relative to the universal support and thereby maintain the tarpaulin under tension when the rod is engaged to the stop element, wherein said tensioning assembly is operative to maintain the bow substantially parallel to the track while under tension.

### FIELD OF THE INVENTION

The present invention relates to the field of tarpaulin systems for transport vehicles. In particular, it relates to a locking and tensioning mechanism for securing a tarp to a vehicle.

### BACKGROUND OF THE INVENTION

Tarpaulin systems (tarps) are commonly used to cover the cargo area of a truck or other vehicle for the transportation of cargo and goods. An advantage provided by tarps is that they can be removed to completely uncover the bed of the vehicle, allowing for faster loading and unloading than with a closed-bed vehicle using doors. However, an issue arises in that the tarp must be capable of maintaining a certain degree of tension when covering the bed to prevent damage to the tarp or the cargo protected by the tarp during transport.

Several systems of tensioning tarps have been proposed. One such is disclosed in U.S. Pat. No. 6,616,211 to Cramaro (“Cramaro”) for a tarpaulin tensioning arrangement. Cramaro uses a lever or leg which is mounted to an extension of the tarpaulin framework and tensioned using a threaded crank which is rotated to move the lever into a catch (fixed) position, and then counter-rotated to move the framework and tension the tarpaulin. A difficulty with the Cramaro system is the need to rotate the crank in opposite directions to ensure that the lever has engaged in the catch position. Another difficulty is that there is no horizontal or vertical restriction on the framework, thus the tensioning forces can be distributed at an angle to the framework, causing angular stresses on the framework and potential leading to bending or more serious damage to the framework.

Thus, there is a need for a tarpaulin tensioning system that is simple to engage, disengage and tension. Furthermore, there is a need for a tarpaulin tensioning system that minimizes angular tensioning forces on the tarpaulin assembly.

It is an object of this invention to partially or completely fulfill one or more of the above-mentioned needs.

### SUMMARY OF THE INVENTION

The invention comprises a) a track for mounting a bow for supporting the tarpaulin, the track enabling longitudinal movement of the bow along the track; b) a universal support coupled to bow and operative to support a rod, the rod being oriented substantially parallel to the track; c) a stop element, the stop element moveable from a position over the track to a position removed from said track, and said stop element operative to engage the rod when positioned over the track; and d) a tensioning adjustment mechanism, as part of one of the universal support, the rod and the stop element, the tensioning adjustment mechanism operative to adjust the position of the rod relative to the universal support and thereby maintain the tarpaulin under tension when the rod is engaged to the stop element, wherein said tensioning assembly is operative to maintain the bow substantially parallel to the track while under tension.

Preferably, the rod is threaded for adjustment within the support. Also, preferably, the stop element further includes a vibration damping element, such as a disk spring, to suppress the vibrational forces from the tensioned tarp. Preferably the stop element is pivotable between a lock position and a release position. Alternatively, the stop element can be detachable.

The invention further comprises a tarpaulin system for a vehicle, comprising the above tensioning assembly in conjunction with one or more tarpaulin sections and bows to support the tarpaulins.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a perspective view of a released tarp tensioning mechanism according to the present invention;

FIG. 2 is a perspective view of the tarp tensioning mechanism of FIG. 1 in the locked position;

FIG. 3 is a top view of FIG. 1;

FIG. 4 is a top view of FIG. 2; and

FIG. 5 is an exploded perspective view of the stop element of FIG. 1.

### DETAILED DESCRIPTION OF THE PREFERRED EMBODIMENTS

The invention presented herein comprises a locking and tensioning assembly for tensioning a tarpaulin (tarp) which is used to cover the cargo area of a vehicle, typically an open-bed or flat-bed truck.

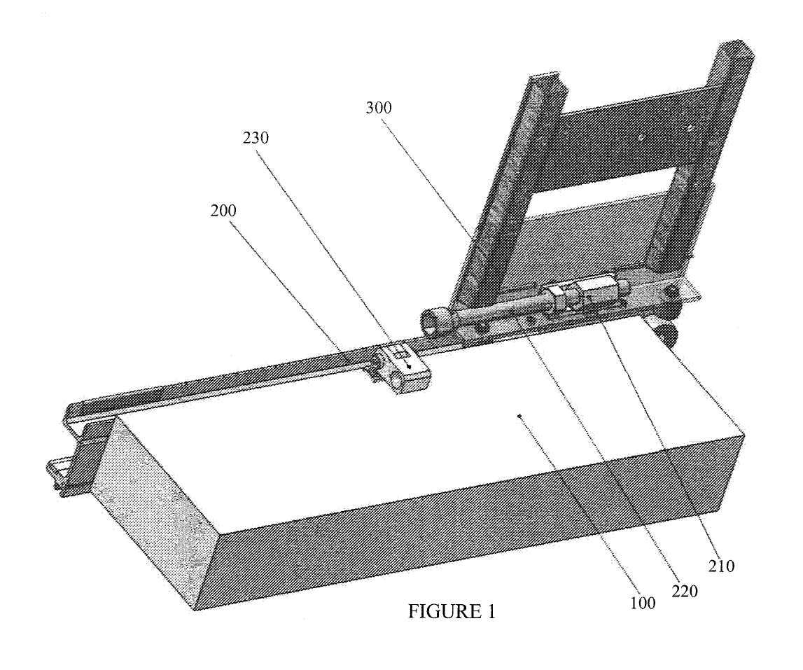

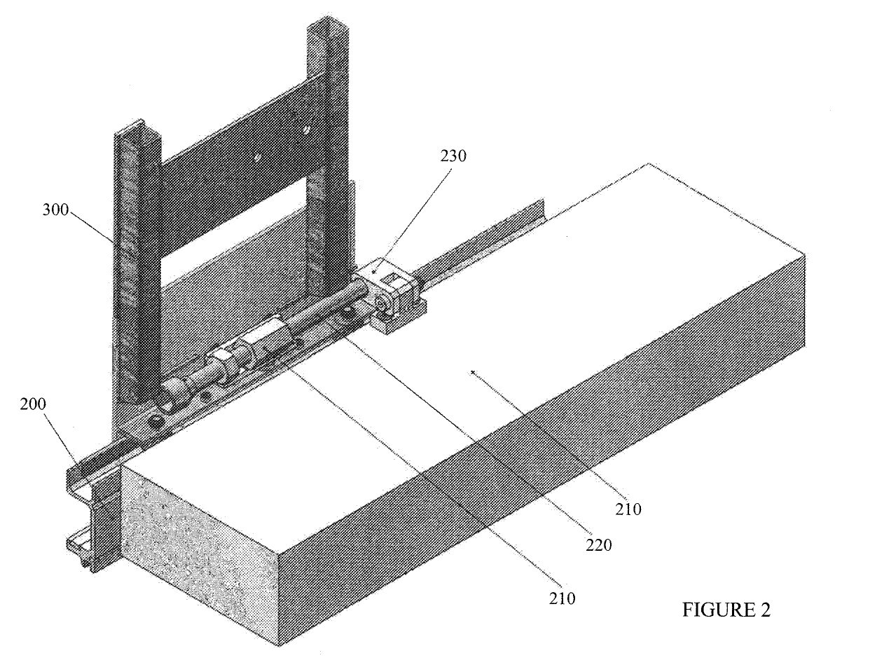

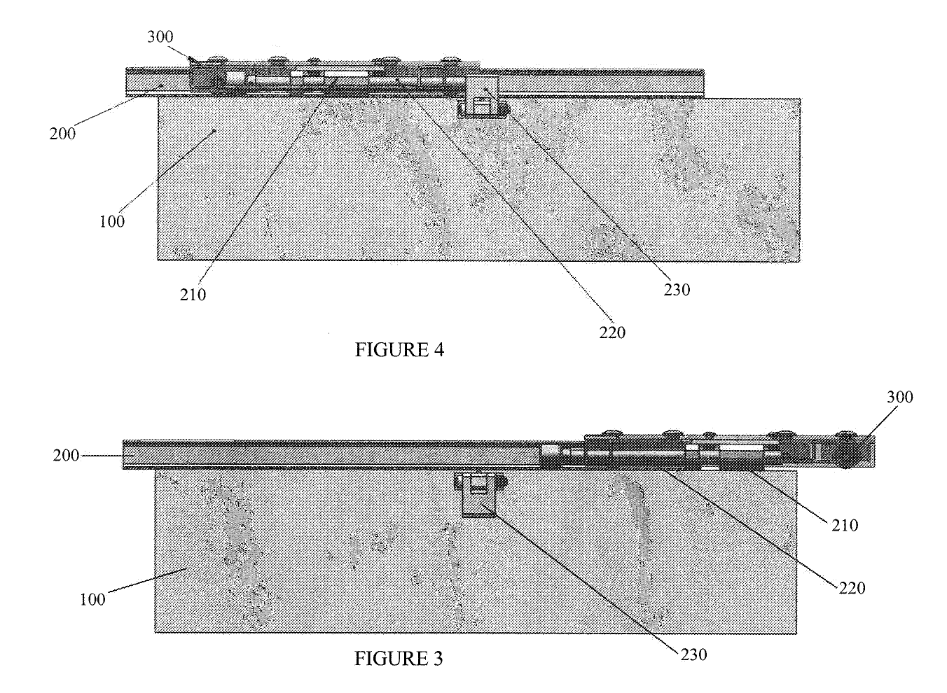

The tarp tensioning assembly is shown in an open (unlocked) position in perspective in FIG. 1 and a closed (locked) position in perspective in FIG. 2. Corresponding top views are shown in FIGS. 3 and 4. The rear bow 300 for mounting the tarpaulin is mounted on a track 200 coupled to the deck floor 100, allowing for movement along a horizontal axis relative to the deck for the purpose of tensioning the tarp (not shown). A universal support 210 is mounted to the bow 300 and supports a rod 220, which can be rotated via threads to adjust its position relative to the support 210.

A stop element 230 is pivotally mounted to the floor 100. The stop element 230 can be pivoted between a release position adjacent to the track 200, as shown in FIGS. 2 and 4, and a lock position over the track 200 and in line with the support 210 and rod 220, as shown in FIGS. 1 and 3. The stop element 230 acts to engage the rod 220 and hold the bow 200, and thus the tarp, in a locked and tensioned position.

As an alternative, stop element 230 can be removable, instead of pivotally mounted. In such an alternative, stop element 230 is held in place by spring pins or similar mechanisms, and is removed when bow 300 is in an unlocked position. When locking is desired, stop element 230 is attached and locked in place in the position shown in FIG. 1. A detachable stop element 230 can be used with a long track 200 to enable the bow 200 to be locked in different positions

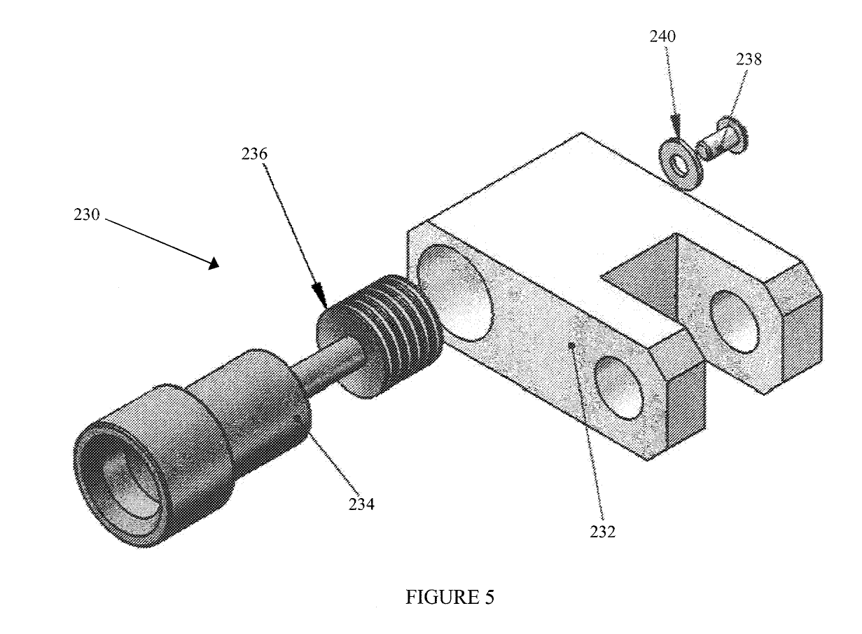

In order to minimize the effect of vibrational forces produced by the tensioned tarp, and to ensure solid engagement with the rod 220, the stop element 230 preferably includes a damping element. One such damping element is shown in FIG. 5. The stop element 230 of FIG. 5 is comprised of a body 232, with a receiving element 234 that engages the rod 220. The receiving element 234 has as disk spring 236 at its base, which acts to reduce the vibrational forces exerted on the rod 220. The receiving element 234 is secured to the body 232 by suitable fasteners such as bolt 238 and washer 240. Alternatives to spring 236 can be used, such as a foam rubber disc or a hydraulic shock. As an additional alternative, the damping element can be incorporated as part of support 210 or rod 220, rather than as part of stop element 230.

In operation, when the tarp is mounted and ready to be placed under tension, the bow 300 is moved back to a position such that rod 220 is beyond the location of the stop element 230. Stop element 230 is then pivoted into the locking position (or inserted, in the case of a removable stop element 230) and rod 220 engages stop element 230 to lock the bow 300 in place. Rod 220 is then rotated to gradually increase the tension on bow 300 and thus, the tarp. As tension is increased, universal support 210 acts to ensure that the tensioning force is directed laterally in the direction of track 200 and vertically, in the direction of bow 300, such that there is no deformation of bow 300, rod 220 or track 200. Additionally, the required force exerted by the operator in tensioning the tarp is thus kept to a minimum.

As shown, rod 220 provides for adjustment of its position relative to support 210 via rotation of threads. However, other tension adjustment mechanisms can be used, including hydraulic or pneumatic mechanisms.

While the above system has been presented in the context of tarpaulin systems for vehicles, the system is equally applicable to any other tarpaulin system that requires adjustment and tensioning.

This concludes the description of a presently preferred embodiment of the invention. The foregoing description has been presented for the purpose of illustration and is not intended to be exhaustive or to limit the invention to the precise form disclosed.

What is claimed is:

1 A tensioning assembly for a tarpaulin, comprising:
a) a track for mounting a bow for supporting the tarpaulin, the track enabling longitudinal movement of the bow along the track;
b) a universal support coupled to bow and operative to support a rod, the rod being oriented substantially parallel to the track;
c) a stop element, the stop element moveable from a position over the track to a position removed from said track, and said stop element operative to engage the rod when positioned over the track; and
d) a tensioning adjustment mechanism, as part of one of the universal support, the rod and the stop element, the tensioning adjustment mechanism operative to adjust the position of the rod relative to the universal support and thereby maintain the tarpaulin under tension when the rod is engaged to the stop element,
wherein said tensioning assembly is operative to maintain the bow substantially parallel to the track while under tension.

2. The tensioning assembly of claim 1, further comprising a vibration suppression mechanism coupled to one of the universal support, the rod, and the stop element, the vibration suppression mechanism operative to dissipate vibrational forces from the tensioned tarpaulin.

3. The tensioning assembly of claim 1, wherein the tensioning adjustment mechanism comprises threading the rod, making the rod rotatable within the universal support to adjust the position of the bow.

4. The tensioning assembly of claims 1, wherein the tension adjustment mechanism is a hydraulic piston incorporated into one of the universal support and the rod.

5. The tensioning assembly of claim 2, wherein the vibration suppression mechanism is a rubber disk within the stop element.

6. The tensioning assembly of claim 2, wherein the vibration suppression mechanism is a hydraulic shock absorber within the stop element.

7. The tensioning assembly of claim 2, wherein the vibration suppression mechanism is a disk spring within the stop element.

8. The tensioning assembly of claim 1, wherein the stop element is moveable by pivoting between the position over said track and the position removed from said track.

9. The tensioning assembly of claim 1, wherein the stop element is moveable by being detachably couplable to the track in the position over said track.

10. A tarpaulin system for a vehicle, comprising:
a) one or more tarpaulins;
b) one or more bows operative to support the tarpaulins; and
c) a locking assembly coupled to the rearmost bow, the locking assembly comprising:
a) a track secured to said vehicle for mounting the rearmost bow for supporting the tarpaulin, the track enabling longitudinal movement of the rearmost bow along the track;
b) a universal support coupled to rearmost bow and operative to support a rod, the rod being oriented substantially parallel to the track;
c) a stop element, the stop element moveable from a position over the track to a position removed from said track, and said stop element operative to engage the rod when positioned over the track; and
d) a tensioning adjustment mechanism, as part of one of the universal support, the rod and the stop element, the tensioning adjustment mechanism operative to adjust the position of the rod relative to the universal support and thereby maintain the tarpaulin under tension when the rod is engaged to the stop element,
wherein said tensioning assembly is operative to maintain the rearmost bow substantially parallel to the track while under tension.

11. The tarpaulin system of claim 10, further comprising a vibration suppression mechanism coupled to one of the universal support, the rod, and the stop element, the vibration suppression mechanism operative to dissipate vibrational forces from the tensioned tarpaulin.

12. The tarpaulin system of claim 10, wherein the tensioning adjustment mechanism comprises threading the rod, making the rod rotatable within the universal support to adjust the position of the bow.

13. The tarpaulin system of claim 10, wherein the tension adjustment mechanism is a hydraulic piston incorporated into one of the universal support and the rod.

14. The tarpaulin system of claim 11, wherein the vibration suppression mechanism is a rubber disk within the stop element.

15. The tarpaulin system of claim 11, wherein the vibration suppression mechanism is a hydraulic shock absorber within the stop element.

16. The tarpaulin system of claim 11, wherein the vibration suppression mechanism is a disk spring within the stop element.

17. The tensioning assembly of claim 10, wherein the stop element is moveable by pivoting between the position over said track and the position removed from said track.

18. The tensioning assembly of claim 10, wherein the stop element is moveable by being detachably couplable to the track in the position over said track.
